(19) United States
(12) Patent Application Publication
(10) Pub. No.: US 2014/0236466 A1
(43) Pub. Date: Aug. 21, 2014

(54) DEVICES AND METHODS FOR ENCOURAGING FUEL EFFICIENT DRIVING BEHAVIOR

(71) Applicant: Gad DORON, Tzur Hadassa (IL)

(72) Inventor: Gad DORON, Tzur Hadassa (IL)

(21) Appl. No.: 13/772,376

(22) Filed: Feb. 21, 2013

(51) Int. Cl. G06F 17/00

(52) U.S. Cl. CPC G06F 17/00; Y10S 903/904
USPC 701/123; 903/904

(57) ABSTRACT

The invention discloses methods and devices for improving the fuel economy of a trip in a vehicle. Sensors are located in and around a vehicle so as to provide at least one computing element a plurality of date for analysis. The computing element may determine the driving environment in which the car is presently located and suggest through an appropriate interface changes in driving behavior so as to optimize fuel use over the coming seconds to minutes. The system allows for best possible fuel consumption during all phases of a trip, whether short or long.

### FIELD AND BACKGROUND OF THE INVENTION

The present invention, in some embodiments thereof, relates to methods and devices for encouraging efficient gas consumption in near-future driving. The instant invention, in some embodiments, describes systems and methods for obtaining data on a driver, his/her vehicle, the driving environment, local conditions, and from these and other data, to analyze and adapt to a fuel-optimal driving model, from which suggestions are passed immediately along to the driver for improved fuel economy in the immediate-future.

The United States consumes approximately 19 million barrels of oil per day equal to the amounts used by China, Japan, India and Russia combined. Most of the oil is used as transportation fuel; the vast majority of the latter is for vehicles, the rest for ships, trains and planes. While there has been of late a growth in US gas and oil production, gas prices are closer to $4 per gallon with compare to $2 per gallon in 2008. Much effort has been expended on alternative vehicular energy sources: ethanol, electric, gas/electric hybrid and biofuels (ignoring hydrogen-based platforms). To date, nothing has successfully replaced the internal combustion engine as the mode of transportation for people and goods in the US.

Since alternative fuels and electric vehicles such as the Chevy Volt have not succeeded in seriously penetrating the US car market, the one alternative left to reduce oil consumption with the exception of higher Federal and state taxes greater fuel efficiency. Cars in the past 20 years have generally become more fuel efficient through the use of lighter materials, more efficient engines and advanced usage of On-Board Diagnostic (OBD) systems. The US additionally requires car manufacturers to meet target mile-per-gallon goals based on a desire to make gas/oil use as efficient as possible.

Yet, the car manufacturers are only one part of the fuel efficiency equation. Drivers themselves play an enormous role in fuel economy. President Obama during his first term made reference to properly inflated tires as well as regular tune-ups as two factors that may help to improve driving efficiency. Yet, beyond the state of car upkeep, the driver holds in his/her hands the possibility of significantly improving car fuel efficiency. Stopping and starting, unnecessary acceleration, frequent lane changes, driving too fast for the weather conditions, not anticipating turns or changes in traffic patterns these and many other factors may contribute to reduced fuel economy with the cost measured in dollars by the driver and in the billions for the US economy. There are ways to make driving more efficient, and computing systems may be used to aid such efforts.

European Patent Application EP 2 320 387 A1 to Raz & Oren describes a method for evaluating fuel consumption efficiency of a vehicle driven by a driver. The method comprises the steps of: a) collecting data associated with said driver's driving performance from a plurality of sensors comprised in the vehicle; b) identifying a plurality of driving events based on the collected data; c) estimating the driver's performance in at least one driving event from among the identified plurality of driving events, wherein that at least one event if poorly performed is associated with increased fuel consumption; and d) based on the estimated driver's performance of the at least one driving event, evaluating a fuel consumption/efficiency of the vehicle driven by that driver.

U.S. Patent Application Publication No. 20120277987 to Marumoto teaches a driving recorder provided with: a data collecting portion that collects driving condition data of a vehicle; a storage portion that stores the driving condition data in a non-volatile manner; a communications portion that performs mutual communications with a mobile telephone terminal, using a cable or wirelessly; and a control portion that comprehensively controls these portions each provided as a functional part, wherein the control portion controls the communications portion to thereby permit the communications portion to transmit and receive the driving condition data to and from the mobile telephone terminal.

European Patent Application No. EP2414183 A1 to Dixon, et al describes a vehicle monitoring device (VMD) comprising a microprocessor programmed to simulate a vehicle's powertrain, that is arranged to receive signals from a vehicle's engine management system in order to produce a real-time simulated model of the vehicle's powertrain operation whence the vehicle's actual instantaneous fuel consumption and/or emissions can be accurately predicted during operation of the vehicle and compared with predetermined or calculated optimum performance characteristics for the powertrain under the pertaining conditions in order to display the instantaneous operating conditions in relation to the optimum under any driving condition. The VMD is advantageously arranged to receive the signals from the on-board diagnostics (OBD or OBD-II or equivalent) port. The VMD is preferably programmed so that the said performance coefficient is used to calculate the instantaneous and/or cumulative quantity or percentage of fuel wasted as a result of non-optimum operation of the vehicle. The invention extends to the display.

U.S. Patent Application Publication No. 20110137508 to Manchado teaches a device for monitoring the process of driving a vehicle consisting of at least the following: a first means of processing a signal; a second means of detecting the vehicle movement; a means for providing an HMI type of interactive display of information for the user; and a means configured for knowing the consumption characteristics of the vehicle and its technical characteristics as far as optimum theoretical behavior; where the means for processing are configured for calculating the optimum consumption according to the characteristics of the vehicle, establishing the driving parameters required for equating the actual consumption to the optimum consumption, displaying this information to the user in the means available for display.

U.S. Patent Application Publication Number 20080027607 to Ertl, et al. describes an assistance system for motor vehicles, in particular an electronic rally-copilot, an over-taking assistant, or right-of-way assistant, includes at least one control unit, which selects data from at least three groups of global, local, and internal data. The selection is by way of a specification of a driver known by the control unit and they are connected together in such a manner that an output signal can be produced relating to the driving dynamics of the motor vehicle. Further, there is provided an assistance system, which simultaneously processes, in an advantageous manner, data prepared by three groups (and/or with the specification of the driver from four groups). Redundancy can be established in an advantageous manner, which is determined, in particular for security-related uses. It can be used, in particular, as a rally-copilot, an over-taking assistant and/or right-of-way assistant for modern vehicles.

The prior art generally describes real-time fuel efficiency determination systems, but do not suggest providing the driver with near-future suggestions as how to improve immediate and near-future fuel efficiency.

### SUMMARY OF THE INVENTION

It is therefore a purpose of the present invention, in some embodiments, to provide real-time information to a driver so as to improve near-future fuel consumption in a vehicle.

The invention includes a method for encouraging fuel efficient driving in a vehicle, including: installing in a vehicle a plurality of forward-looking sensors, motion and orientation sensors, computing elements, and a driver interface at predetermined positions in the vehicle; allowing the sensors to analyze the driving environment immediately in front of and to the sides of the vehicle; analyzing data from the sensors with the computing elements to determine optimal future driving behavior by a predetermined fuel consumption model for best fuel economy for the vehicle in the environment; and, providing to the driver suggested optimal immediate-future driving tactics via the driver interface as to minimize immediate-future fuel consumption by the vehicle.

In one aspect of the method, the sensors include any of the following: cameras, infra-red detectors, RADAR, motion sensors, and gyroscopes, GPS, accelerometers, magnetometers, or any combination thereof.

In another aspect of the method, the driver interface includes a mobile or cellular component, touch-sensitive screen, GUI, HMI or HUI based on vision, sound, or vibration.

In another aspect of the method, the computing elements are in communication with an onboard diagnostic system.

In another aspect of the method, the vehicle is realized as a car, truck, motorcycle, bus, train, jeep, military vehicle, or moped.

In another aspect of the method, there is an addition step of acknowledging implementation of the driving tactics by the driver.

In another aspect of the method, the suggested optimal immediate-future driving tactics include but are not limited to changing lanes, slowing down, speeding up, turning on lights, braking, preparing to stop, honking, and changing gear.

In another aspect of the method, the fuel consumption is related to the efficiency of a combustion engine.

In another aspect of the method, the fuel consumption is related to the efficiency of an electrical engine.

In another aspect of the method, the fuel consumption is related to the efficiency of a hybrid engine.

In another aspect of the method, the driver is realized as a non-human component of the vehicle.

In another aspect of the method, the computing elements are adapted to utilize image and sensing data processing techniques to identify stop signs, street signs, overhead driving notices, speed limit signs, direction signs, other cars, constant speed of other vehicles, other cars braking or changing lanes, traffic lights, rain, up or downhill level, pedestrians, vehicles, bicycles, scooters, motorcycles, trees, road signs, separation lines, shoulders, margins and stop lines.

The invention includes a device for allowing optimal immediate-future driving behavior associated with a vehicle, including the following: forward-looking sensors, motion and orientation sensors installed in the vehicle and adapted to continuously record the driving environment around the vehicle; computing elements adapted to receive data from the sensors, identify from the data a plurality of features associated with the driving environment in which the vehicle is operated, and determine optimal immediate-future driving actions to minimize fuel consumption; and, a driver interface for providing a driver of the vehicle with suggestions based on the optimal immediate-future driving actions determined by the computing elements.

In one aspect of the device, the sensors are adapted to be in communication with the computing elements.

In another aspect of the device, the computing elements are adapted to utilize image and sensing data processing techniques to identify stop signs, street signs, overhead driving notices, speed limit signs, direction signs, other cars, constant speed of other vehicles, other cars braking or changing lanes, traffic lights, rain, up or down hill directions, pedestrians, bicycles, scooters, motorcycles, vehicles, trees, road signs, separation lines, shoulders, margins and stop lines.

In another aspect of the device, the computing elements are further adapted to analyze the driving environment and deliver to the driver interface optimal strategies for optimizing immediate-future fuel consumption.

In another aspect of the device, there is additionally a GPS component adapted to be in communication with the computing elements.

The invention additionally includes a method for allowing optimal immediate-future driving behavior associated with a vehicle, including the following: installing in a vehicle a plurality of forward-looking sensors, motion and orientation sensors, mobile computing elements, and a driver interface at various positions in the vehicle; allowing the forward-looking sensors, motion and orientation sensors to analyze the driving environment immediately in front of and to the sides of the vehicle as the vehicle travels from a starting position to a final driving destination; analyzing data from the sensors and data from the vehicle's On Board Diagnostic System data with the computing elements to determine optimal future driving behavior for best fuel economy for the vehicle in the environment; and, providing to the driver via the driver interface optimal immediate-future driving tactics via the driver interface so as to minimize fuel consumption by the vehicle.

In one aspect of the method, the optimal immediate-future driving tactics are based, in part, on a navigation system data, for example, but not limited to, GPS coordinates.

In another aspect of the method, the computing elements are associated with a laptop computer, handheld tablet, a cellular phone, mobile computing device, or other element that may be removed from the vehicle.

In another aspect of the method, the best fuel economy is provided to the driver through the driver interface.

Unless otherwise defined, all technical and/or scientific terms used herein have the same meaning as commonly understood by one of ordinary skill in the art to which the invention pertains. RADAR, GPS, forward-looking sensors, motion sensors, computing devices, and other terms may generally have their normal meanings in their respective arts. Forward-looking sensors may generally refer to cameras and RADAR-based elements. “Immediate future” with respect to time may refer to the present moment and up to one minute beyond the present moment in the driving process.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. It is noted that similar elements in various drawings will have the same number, advanced by the appropriate multiple of 100.

In the drawings:

FIG. 1 shows a schematic view of an embodiment of the instant invention;

FIG. 2 shows a schematic view of an alternative embodiment of the instant invention;

FIG. 3 shows a method embodiment associated with the instant invention; and,

FIG. 4 shows a schematic view of a car interior in relation to the Example provided.

### DESCRIPTION OF SPECIFIC EMBODIMENTS OF THE INVENTION

The present invention, in some embodiments thereof, relates to systems and devices for allowing for significant fuel economy when operating a vehicle. Without being bound by any particular theory, the following discussion is offered to facilitate understanding of the invention. The present invention, in some embodiments, provides for increased fuel efficiency through providing driving suggestions to a driver, the suggestions based on car, driver, and driving condition specific data.

For purposes of better understanding, some embodiments of the present invention are illustrated in the figures of the drawings.

### First Embodiment

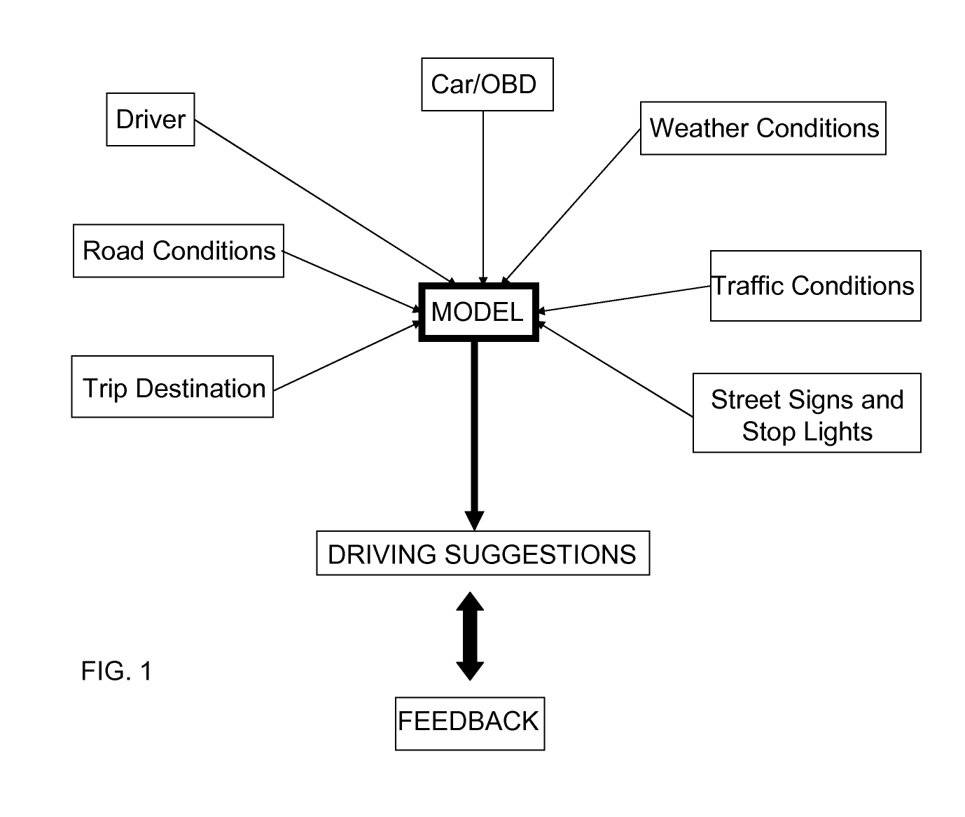

Attention is turned to FIG. 1 which shows an embodiment of the instant invention. As shown in the figure, multiple factors contribute to produce a real-time model of care driving behavior and associated immediate-future fuel consumption. A brief summary of the factors are herewith included:

Road conditions: Climbing, going horizontal, or going down. Rolling resistance depending on the road surface.

The Driver: Different drivers have different driving behaviors. By knowing the driver and his/her driving tendencies, one may more accurately model both expected future driving behavior (turning with high speed, speeding up to get through a yellow light; changing lanes frequently, etc.) as well as design suggested behavior accordingly. Driver details are optional inputs, where data concerning a given driver are lacking

The Car: Vendor, model, year of manufacturing. Type of the engine/car: internal combustion, diesel/hybrid/electric. Gear type: automatic/manual. Cold engine. Rolling resistance depends not only on road conditions, but on tires type, air pressure, how many passengers or in general car weight.

Nothing contributes more to the overall efficiency of fuel use than the car or other vehicle itself. A system using an On-Board Diagnostic (OBD or OBD-II) protocol has a plethora of real-time data regarding the engine and the various electronic, pneumatic, and drive systems of the car. These data may optionally be employed by some embodiments of the instant invention. Knowing how the car is running, how well the engine is performing may be of use for constructing an accurate model for suggested future driving actions.

Weather Conditions: Inclement weather (snow, rain-slick streets, etc.), wind, extreme heat—these and other factors can significantly affect tires as well as engine/fuel performance. Extreme weather also may require heating or cooling of the passenger cabin, demanding more fuel use by the car. By including weather conditions outside, on the road, and their impact in the car, a model of future fuel use may more accurately suggest actions/activities for optimized fuel consumption. Optimized means best possible, not some abstract absolute very good.

Traffic Conditions: It is well-known in the art that idling, start/stop driving and frequent braking reduce fuel efficiency. It is critical for constructing an accurate immediate-future fuel consumption model that all known traffic conditions be known. Such factors include but are not limited to presence, number, and location, speed and direction of other vehicles, pedestrians, two-wheeled (motored or pedal-powered) vehicles, the position of pedestrians, the condition of the roadway, and both the allowable speed limit and the realistic speed limit for the prevailing conditions.

Street Signs and Street Lights: Any model for optimized near-future fuel consumption should take into account street signs, traffic lights, and prevailing laws (like right turn on red). Today, such information must be gleaned from sensors and converted to information for a model; in the future, street signs, traffic lights and the like may be able to communicate wirelessly with the in-vehicle system or similar computing device to warn or inform of present traffic regulations. The importance of such information is clear: if fuel efficiency would be improved by speeding up, but the onboard computing systems determine that a red light is up ahead, the model developed for immediate-future driving must tell the driver to slow down and/or prepare to stop. If 30 mph would be the optimal speed at a certain location of a road in bad repair, but the minimum speed is 45 mph, the model will suggest 45 mph, the lowest allowable speed that gives the optimal fuel efficiency for the conditions present.

Once the model has been constructed for all of the relevant factors outlined above, a suggestion is passed along to a driver. The suggestion may be in a spoken, visual, text or other format. The suggestion will be as clear and simple as possible: change lanes, decrease speed (by braking or removing foot from pedal, either possibly leading to reduced speed) to 50 mph, prepare to stop, brake more evenly, etc. The suggestions are kept simple so as not to confuse the driver; thus, the driver is unaware of the enormous data required and computing power used to give simple suggestions like braking, turning, or increasing speed. Once the suggestion is proffered, it is up to the driver to decide whether to implement the suggestion. If it is implemented and the result for improved fuel efficiency is achieved, the system may give positive feedback to the driver so as to encourage future acceptance of suggestions. The driver may decline to implement a suggestion based on his/her own read of the driving conditions and personal needs (running late, etc.).

Not shown in FIG. 1 is a navigation system. GPS like navigation system is not required for the instant invention, but in cases where GPS is applied, information from a GPS device may aid in more efficient driving. By additionally knowing the intended route, the types of streets involved as well as the presence of stop lights, stop signs, and the like, the computing device can potentially build a more accurate model for fuel consumption and also make more accurate suggestions earlier and more frequently. A GPS-type antenna may be useful for knowing vehicle direction and speed.

### Second Embodiment

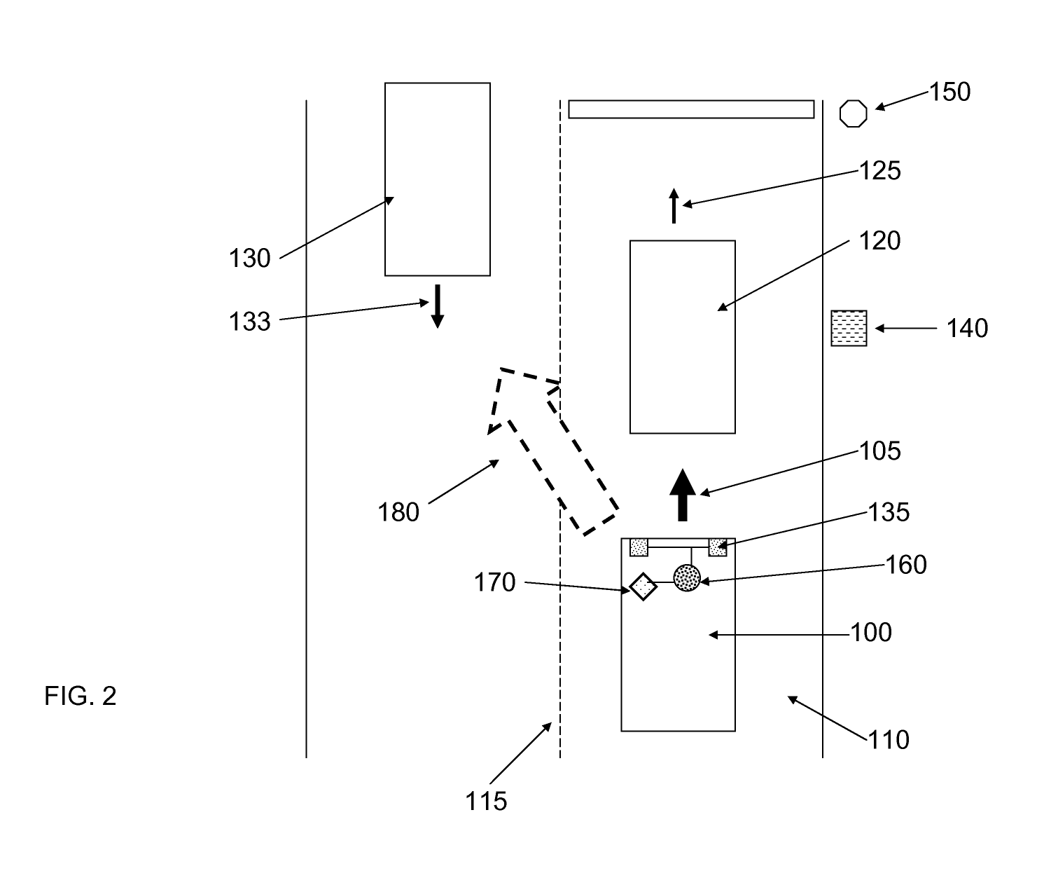

Attention is turned to FIG. 2 which shows a schematic drawing of an embodiment according to the instant invention, as seen from above. A first car 100 is travelling at relatively high speed 105 on a two lane highway 110 separated by a broken white line 115. A second car 120 is travelling in the same direction as the first car 100, but at a significantly reduced speed 125. A third car 130 is travelling in an opposite direction 133 as shown. The first car includes a plurality of sensors 135 providing raw optical and other data for analysis of the driving situation by a dedicated computing device 160 that may be realized as an independent element as shown or as a component of the first car's 100 in-vehicle computer or diagnostic systems (not shown). Specifically, the sensors 135 may include RADAR, cameras, sensors, forward-looking sensors, motion detectors, and other elements that allow for as complete a picture of the driving, street, and weather conditions around the first car 100 as is possible. Sensors 135 may be a permanent part of the first car 100 or they optionally may be transiently brought to and removed from the first car 100 via a mobile computing device, mobile phone or the like. Alternatively, some elements of the instant invention may be permanently installed in a vehicle, while other elements may be brought and removed. It is understood that said sensors 135, while described as being forward-directed, may also make measurements relative to the side of the first car 100 or in some cases even behind it. The sensors 135 analyze the condition of the highway 110, other cars 120 & 130, passing rules (as per the broken white line 115), street signs 140, weather and other driving-related parameters. The driver (not shown) of the first car 110 would like to pass 180 the slower second car 120 (whose speed is identified by said sensors 135), but the sensors 135 detect the presence of the third car 130 as well as the street sign 140 identifying a stop sign 150 one hundred meters forward. The sensors send raw data to a computing device 160 which analyzes the data, identifies elements, enters data from the OBD or from predetermined fuel consumption models and then provides driving suggestions to a driver interface 170. The suggestions may be sent wirelessly or through a wired connection and represent the actions (or lack of actions) which will yield the optimal fuel consumption for the first car 100 over the next seconds to minutes of driving time. The driver interface 170 may provide verbal suggestions, presentation of information on an appropriate display or graphical user interface, or a combination thereof. The suggestions are relayed to driver, namely to slow down according to the situation as shown in FIG. 2, as passing 180 is highly dangerous and a stop sign 150 has been identified as being close through the presence of an informative street sign 140. The driver can choose what to do, but should he/she slow down, the computing device 160 may give positive feedback to the driver via the driver interface 170, the positive feedback possibly including data as to improved or optimized fuel consumption.

The sensors 135 associated with the instant embodiment can measure a plurality of events and phenomena. Cameras, RADAR devices, motion sensors, and the like continually record the environment immediately in front of and around the first car 100. The raw data are passed to the computing device 160 where software converts the raw images and signal data into detailed information regarding the driving environment. The software allows for the identification of elements such as cars, street signs, stop lights, surface type, weather, presence of wet roads, and much more. As suggested in FIG. 2, cars 120 & 130 in proximity to the first car 100 may be identified by the computing device 160, their direction and speed determined. Additionally, street signs 140, lane rules (as represented by the line 115) may optionally be determined. Atmospheric conditions such as rain and by extension a wet driving surface (not shown) may be identified, such information having an impact on optimal speed and braking distances. The computing device 160 is adapted to either work alone or with inputs from the various computers and systems associated with the OBD (not shown). In some embodiments, the computing device 160 may be a component of the OBD (not shown). The computing device 160 receives the raw data from the sensors 135, processes the data, determines the parameters that may be taken from the data and builds a model of the current and anticipated immediate-future driving situation. The computing device 160 may then create suggestions for driving actions that will lead to improved fuel economy. The computing device 160 may transmit these suggestions to the driver interface 170, where they are presented to the driver in a manner so as not to distract the driver from driving the car 100. The driver may choose to implement the suggestions or ignore them. Should the driver implement the suggestions, positive feedback may be delivered from the computing device 160 to the driver interface for presentation to the driver.

A fuel consumption model may be used for comparing present driving phenomena to optimized driving parameters. Such a model may be proprietary, car-specific or may be “off-the-shelf” (for example: http://www.enm.bris.ac.uk/teaching/projects/2009_{—}10/tg5412/Poster.pdf). The fuel consumption model is used in conjunction with data from said sensors 135 to allow said computing device 160 to suggest via the driver interface 170 the optimal action in the coming few seconds to tens of seconds of driving.

The car 100 may be realized as any form of vehicle, including but not limited to a car, a bus, a truck, a moped, a motorcycle, a train, or a military vehicle. The car 100 may have a regular combustion engine, be a hybrid, have an electric engine or run on alternative fuels. The driver may be a human being or it may be a computer, as has been accomplished with cars from Google, for example (http://en.wikipedia.org/wiki/Google_driverless_car).

### Third Embodiment

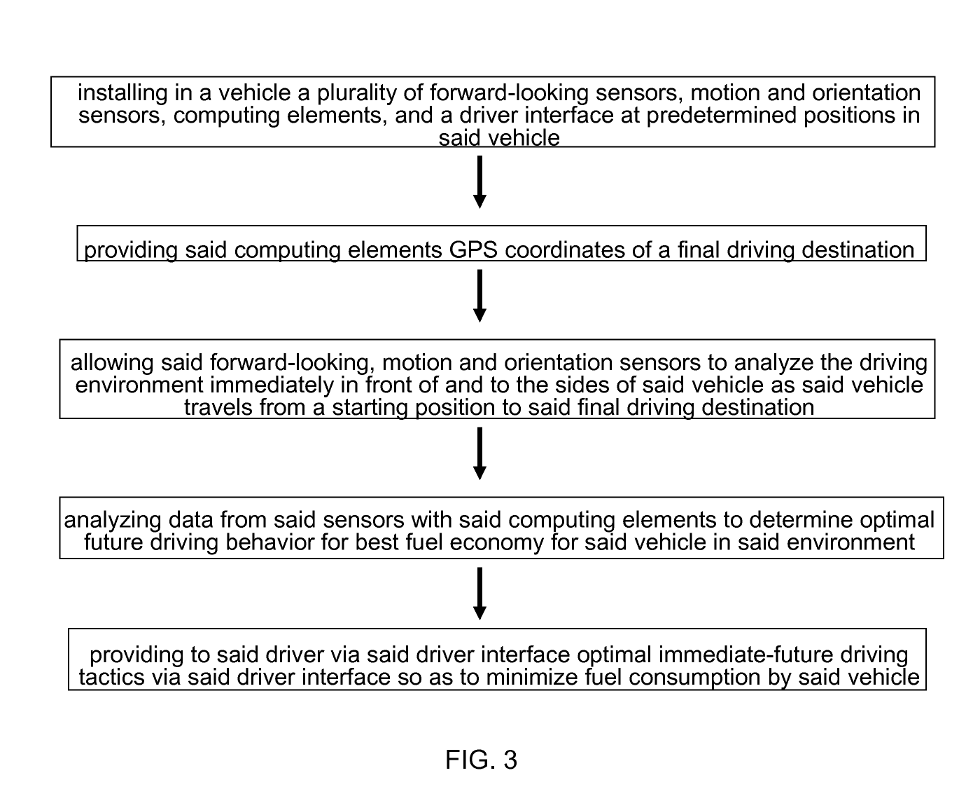

Attention is turned to FIG. 3, which shows a method associated with an embodiment of the instant invention. The figure details a method for allowing optimal immediate-future driving behavior associated with a vehicle, including the following: installing in a vehicle a plurality of forward-looking sensors, motion and orientation sensors, computing elements, and a driver interface at optionally predetermined positions in said vehicle; providing said computing elements GPS coordinates; allowing said forward-looking sensors, motion and orientation sensors to analyze the driving environment immediately in front of and to the sides of said vehicle as said vehicle travels from a starting position to said final driving destination; analyzing data from said sensors with said computing elements to determine optimal immediate-future driving behavior for best fuel economy for said vehicle in said environment; and, providing to said driver via said driver interface optimal immediate-future driving tactics via said driver interface so as to minimize fuel consumption by said vehicle. The sensors may be embedded on the inside or outside of the vehicle or both. The sensors are adapted to be linked either through wires or wirelessly to the computing elements. The computing elements are adapted to accept data from the sensors and interpret said data to determine specific predetermined pieces of information relating to the driving environment around the car. The GPS coordinates may be provided by an external GPS device or one associated with either the vehicle or the computing elements. A vehicle may have all of the sensor types listed above or may sport some but not all. The sensors may be realized as separate elements or may be realized as one device with forward-looking sensors, motion and orientations sensors components of a single device.

### EXAMPLE

An individual driving a Cadillac Escalade has an embodiment of the instant invention associated with her vehicle. Specifically, forward- and side-looking RADAR and motion sensors are installed at fixed points on the outside of the car, while the individual drive's Samsung smartphone is adapted with both hardware and software elements to provide the following: GPS for position sensing; a camera for continuously photographing the driving environment in front of and around the car; a computing element for receiving and processing raw data, comparing said data to a predetermined fuel economy model for the Escalade and for determining driving actions to be taken in the next 1 to 60 seconds of driving; and, a voice-based driver interface for suggesting to said driver what actions would best keep fuel efficiency in driving. Other cameras may be hardwired into predetermined positions on the car.

The driver enters the Escalade and places her smartphone on a fixed holder at a predetermined position in the car. The holder is positioned so as to allow for optimal smartphone camera action in continually photographing the environment around the car; additionally, RADAR and any other sensors are hard-wired to provide the smartphone data at its fixed holder. The driver begins her trip to work, and the embodiment of the instant invention allows for camera, RADAR, GPS, and motion sensor data to be fed to the computing element associated with the Samsung Smartphone; the computing element converts the raw data to driving environment parameters which may be compared to the predetermined fuel efficiency model specific for the Escalade. Escalade in-vehicle diagnostic data are also fed into the Samsung smartphone to provide a more complete picture of the car and its environment. The computing element determines the optimal driver behavior--brake, speed up, keep current speed, turn to a different strip, etc.--and provides suggestions to said driver via the driver interface component associated with the smartphone. The driver may choose to implement the suggestions or ignore them. Should the driver implement a suggestion--to pull foot off of the gas pedal early for a traffic light turning from green to red, for example--the computing element may give her a compliment. The computing element analyzes new real-time data throughout the trip and continuously compares the data to the fuel consumption model so as to give optimal suggestions for achieving best possible fuel consumption on the trip. When the half-hour trip to work is finished, the computing element determines the savings in fuel usage and informs the driver on the touch screen of the smartphone that she saved 15% fuel during the trip by employing the suggestions given throughout the trip.

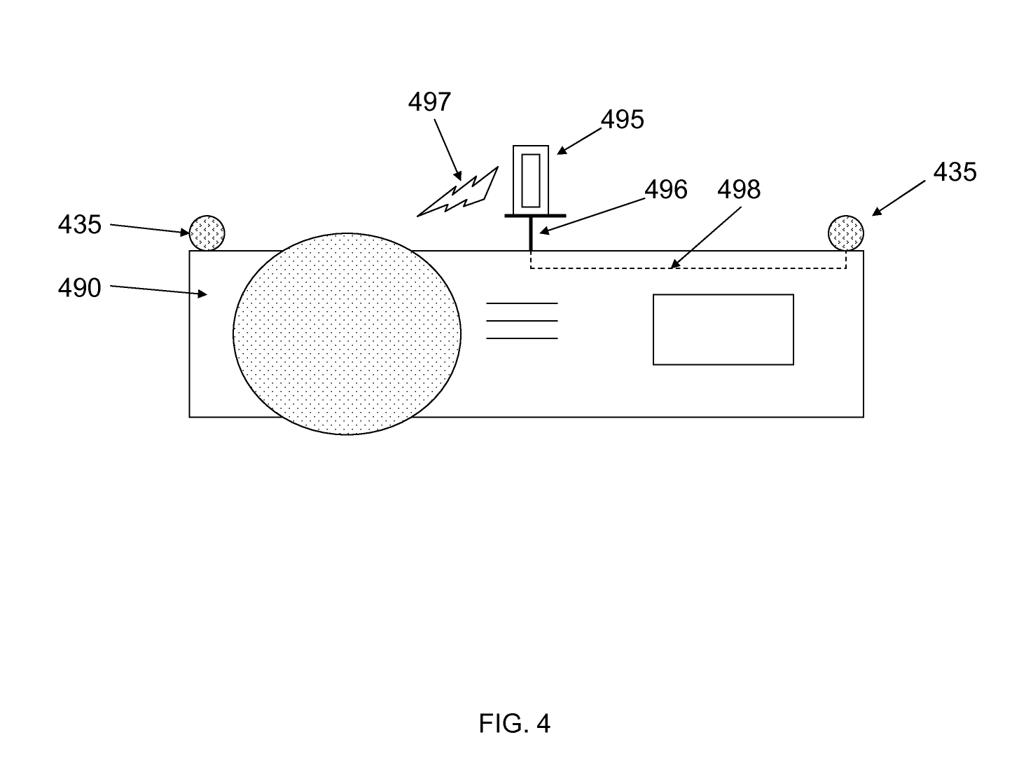

Attention is turned to FIG. 4 which shows a schematic view of a dashboard 490 of the Escalade described in this example. RADAR-based sensors 435 are positioned above the dashboard facing the front window (not shown). The smartphone 495 is placed in a holder 496 that allows for a clear forward view. The smartphone 495 provides the following capabilities: computing element for receiving and processing all relevant data; forward-looking camera; GPS; maps; fuel consumption model for the Escalade; and, driver interface where it can make an audible sounds 497 to provide suggestions to driver as to what immediate-future steps should be taken for optimal fuel economy. The smartphone 495 may optionally receive data from the car's onboard diagnostic systems and the smartphone 495 may be either the sole computing element or joined with others that are hard-wired into the car. The sensors 435 may optionally be hard-wired 498 to the smartphone 495 holder 496. The smartphone 495 is removed by driver when driver exists the Escalade.

As used herein the term “about” refers to ±10%.

The terms “comprises”, “comprising”, “includes”, “including”, “having” and their conjugates mean “including but not limited to”.

The term“consisting of means “including and limited to”.

The term “consisting essentially of” means that the, method or structure may include additional ingredients, steps and/or parts, but only if the additional ingredients, steps and/or parts do not materially alter the basic and novel characteristics of the claimed composition, method or structure.

Forward-looking devices/elements may include any of the following: video camera module, RADAR module, IR Camera module and combination thereof. Forward-looking devices/elements may be integrated into mobile and/or cellular device.

Forward-looking devices may cover a solid angle in the range of 0 to 2pi steradian [sr] with distance r [m].

Motion sensors may generally include any of the following: Accelerometer(x), Accelerometer(y), Accelerometer (z), gyroscope(x), gyroscope(y), gyroscope (z), magnetometer(x), magnetometer(y), magnetometer(z) and combination thereof. Motion sensors may be integrated into mobile and/or cellular device.

Position sensors are generally realized as devices with GPS capabilities. Orientation sensors may be integrated in mobile and/or cellular device

Computing systems or elements may be integrated with an OBD protocol, in-vehicle computing device, a smartphone, handheld computer, tablet computer, or other device. Computing systems or elements may be a part of the vehicle in which they are used or they may be separate units that may be routinely removed from the vehicle.

Computing elements generally may be described with the following attributes:
Responsible for video frames acquisition and real time image processing that identifies driving related environment factors. Identify vehicles ahead, their speed and acceleration, road conditions, road signs, etc. (Techniques: vanishing points finding, RANSAC, thresholds, histogram, optical flow, etc.).
Evaluating current status of the vehicle from plurality of sensors (speed, acceleration, orientation, horizontal or not etc.) & OBD.
Estimating future driver behavior based on above, and providing driver with feedback in order to minimize fuel consumption, based on vehicle fuel consumption model (for example same car models, from the same year)

Fuel consumption model may be along the lines of the following equation: for example, but not limited to:

In order to calculate the vehicle's instantaneous fuel consumption Q we need to find the power that the engine needs to supply, given by

Pe=Preq/(t

Where Pe is the actual power delivered to the wheels that can be modeled as the power obtained from the fuel Pf scaled down by the efficiencies of the transmission system (t and the efficiency of the engine (e can be extracted from a related engine efficiency map, that is

Pe=(e(tPf

Preq is the power required to keep the car moving in a given speed and it takes into account the external powers work on the car like gravity aerodynamics act'. The amount of fuel Q required for a given engine power will then be

Q=Pf/Ef=Pe/(e(tEf

Where Ef is the energy density in J/m3 for a given type of fuel (petrol or diesel).

The model may be calculated by different equations and/or algorithms, using one or a plurality of inputs to determined optimal driving behavior for the immediate future.

Examples of the driver interface include but are not limited to: mobile or cellular, screen, GUI, HUI by vision, sound, or vibration-era combination of any of these means.

Driving environment factors analyzed by the computing elements include but are not limited to stop signs, other cars constant speed, other cars breaking, lane changing, traffic lights, rain, up or down hill, pedestrians, vehicles, trees, Road signs (separation line, margin, stop line.)

OBD-II standard device may allow reading data from plurality of in-vehicle sensors; such as but not limited to engine RPM, engine load, Fuel flow rate, throttle position, fuel trim.

Engine behavior data, as above will allow providing driver with feedback in order to minimize fuel consumption, based on vehicle fuel consumption model, and improved fuel consumption model (and therefore improve fuel consumption optimization) based on specific car behavior (and not only based on average fuel consumption for same car vendor, car model, and car manufacturing year).

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. The present invention could be employed for a wide variety of vehicles, with human or non-human drivers. All vehicle engine types are amenable to the instant invention.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

GPS position and real-time traffic conditions may also be used to allow for greater fuel efficiency.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method for encouraging fuel efficient driving in a vehicle, including:
installing in a vehicle computing elements, a smartphone, and a driver interface at predetermined positions in said vehicle;
directing said smartphone to acquire data relating to driving environment immediately in front of and to the sides of said vehicle;
analyzing data from said smartphone with said computing elements to determine optimal future driving behavior for best fuel economy by a predetermined fuel consumption model for said vehicle in said environment; and,
providing to a driver suggested optimal immediate-future driving tactics via said driver interface as to minimize immediate-future fuel consumption by said vehicle as per said model.

2. The method according to claim 1, further including sensors selected from the following:
cameras, infra-red detectors, RADAR, motion sensors, and gyroscopes, GPS, accelerometers, magnetometers, or any combination thereof.

3. The method according to claim 1, wherein said driver interface is selected from a mobile or cellular component, touch-sensitive screen, GUI or HMI based on vision, sound, or vibration.

4. The method according to claim 1, further including the step of directing said computing elements to communicate with an onboard diagnostic system (OBD), wherein said computing elements may access predetermined information from said OBD.

5. The method according to claim 1, wherein said vehicle is realized as a car, truck, motorcycle, bus, train, off-road vehicle, military vehicle, or moped.

6. The method according to claim 1, further including the step of acknowledging implementation of said driving tactics by said driver.

7. The method according to claim 1, wherein said suggested optimal immediate-future driving tactics are selected from changing lanes, slowing down, speeding up, turning on lights, braking, preparing to stop, honking, and changing gear.

8. (canceled)

9. The method according to claim 1, wherein said smartphone is realized as a Samsung smartphone.

10. (canceled)

11. The method according to claim 1, further including the step of installing a computer to serve as said driver of said vehicle.

12. The method according to claim 1, wherein said computing elements are further adapted to utilize image and sensing data processing techniques to identify stop signs, street signs, overhead driving notices, speed limit signs, direction signs, other cars, constant speed of other vehicles and their distance, other cars braking or changing lanes, traffic lights, rain, up or down hill directions, pedestrians, vehicles, bicycles, scooters, motorcycles, trees, road signs, separation lines, shoulders, margins and stop lines.

13. A device for allowing optimal immediate-future driving behavior associated with a vehicle, including the following:
at least one mobile computing device;
motion sensors installed in said vehicle and adapted to continuously monitor the driving environment around said vehicle;
computing elements adapted to receive data from said mobile computing device, identify from said data a plurality of features associated with said driving environment in which said vehicle is operated and determine optimal immediate-future driving actions to minimize fuel consumption; and,
a driver interface for providing a driver of said vehicle with suggestions based on said optimal immediate-future driving actions determined by said computing elements.

14. The device according to claim 13, wherein said motion sensors are adapted to be in communication with said computing elements.

15. The device according to claim 13, wherein said computing elements are adapted to utilize image and sensing data processing techniques to identify stop signs, street signs, overhead driving notices, speed limit signs, direction signs, other cars, constant speed of other vehicles, other cars braking or changing lanes, traffic lights, rain, up or downhill level, pedestrians, bicycles, scooters, motorcycles, vehicles, trees, road signs, separation lines, shoulders, margins and stop lines.

16. The device according to claim 14, wherein said computing elements are further adapted to analyze said driving environment and deliver to said driver interface optimal strategies for optimizing immediate-future fuel consumption.

17. The device according to claim 15, further including the step of monitoring said vehicle's course via a GPS position component adapted to be in communication with said computing elements.

18. A method for allowing optimal immediate-future driving behavior associated with a vehicle, including the following:
installing in a vehicle mobile computing elements, and a driver interface at predetermined positions in said vehicle;
directing said mobile computing elements to analyze the driving environment immediately in front of and to the sides of said vehicle as said vehicle travels from a starting position to said final driving destination;
analyzing data from said mobile computing elements and data from a vehicle's onboard diagnostic system with said mobile computing elements to determine optimal future driving behavior for best fuel economy for said vehicle in said environment; and,
providing to a driver via said driver interface optimal immediate-future driving tactics via said driver interface so as to minimize fuel consumption by said vehicle.

19. (canceled)

20. The method according to claim 18, wherein said mobile computing elements are associated with a laptop computer, handheld tablet, a cellular phone, mobile computing device, or other element that may be removed from said vehicle.

21. The method according to claim 18, wherein said best fuel economy is provided to said driver through said driver interface.
